(19) United States
(12) Patent Application Publication
(10) Pub. No.: US 2009/0094555 A1
(43) Pub. Date: Apr. 9, 2009

(54) ADAPTIVE USER INTERFACE ELEMENTS ON DISPLAY DEVICES

(75) Inventor: Tomi VIITALA, Siivikkala (FI)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: NOKIA CORPORATION

(21) Appl. No.: 11/868,050

(22) Filed: Oct. 5, 2007

(51) Int. Cl. G06F 3/048

(52) U.S. Cl. 715/838

(57) ABSTRACT

An apparatus, method, and computer program product for providing adaptive user interface elements on display devices are provided. The apparatus includes a processing element configured to provide for a display of an image of a user interface element, where actuation of the user interface element invokes a certain operation. The processing element is also configured to monitor interaction with the user interface element and to provide for a modified image of the user interface element based on the interaction with the respective user interface elements. User interface elements may be modified in various ways to allow a greater portion of the display of the application to be seen and experienced. Furthermore, the interaction may be monitored in different ways, and a user input regarding presentation of the modified image may also be received.

### TECHNOLOGICAL FIELD

Embodiments of the present invention relate generally to user interface technology and, more particularly, relate to a method, apparatus, and computer program product for providing adaptive user interface elements on display devices.

### BACKGROUND

The use of mobile terminals for communication, education, and recreation is growing ever more popular. As a result, new and more sophisticated applications for such mobile terminals continue to be developed. Often, an application implemented by a mobile terminal, such as a mobile telephone or a portable digital assistant (PDA), requires a user to interact with a hardware user input interface, such as an interface including keys and buttons, in order to provide inputs for controlling the application. A mobile telephone, for example, may have a housing that includes a keypad with hardware alpha-numeric keys that allow the user to dial a telephone number. The mobile phone housing may also include hardware “up” and “down” keys and a Select key to permit the user to scroll through a menu and select a particular entry.

If a hardware user input interface does not provide for all of the user inputs that an application requires, the mobile terminal may not be able to run the application, or the application may not function properly or fully on the mobile terminal. In this case, a software solution has been developed to compensate for the deficient hardware. A software platform may be implemented by the mobile terminal in order to provide “virtual” user interface elements that are capable of receiving user inputs. For example, if an application requires a special Function button that is not provided by the mobile terminal hardware, a software platform may provide for the special Function button to be displayed overlying the display of the application or in a dedicated area of the display of the application. A user's actuation of the “virtual” special Function button in this example, such as via a touch event or selection of the “virtual” button via hardware keys, e.g., soft keys, would be received as a valid input by the application, and the corresponding operation would be executed by the application.

The provision of user interface elements by a software platform in many cases, however, obscures display of the application itself. In particular, when several user interface elements are required to be displayed, or the user interface elements are large in size, a user may not be able to view certain portions of the application that are displayed behind the user interface elements.

Thus, there is a need to provide for the display of user interface elements in a way that allows a user to view more of the application and still provides the user ability to invoke desired operations of the application.

### BRIEF SUMMARY

A method, apparatus and computer program product are therefore provided for providing adaptive user interface elements on display devices. In particular, a method, apparatus and computer program product are provided that monitor interaction with user interface elements and provide a modified image of the user interface elements based on the interaction. In this way, certain user interface elements may be de-emphasized if not utilized so that a greater portion of the display of the application may be seen and experienced.

In one exemplary embodiment, a method and computer program product for providing adaptive user interface elements on display devices are provided. The method and computer program product provide for a display of an image of at least one user interface element associated with an application, wherein actuation of each user interface element invokes an operation related to the application. The method and computer program product also monitor interaction with each user interface element and provide for a modified image of the at least one user interface element based on the interaction with the respective user interface element.

In some cases, providing for the modified image includes adjusting at least one characteristic of the image of the at least one user interface element, such as a transparency, a size, an animation, or a coloring of the image. Alternatively or in addition, the image of the user interface element(s) may be re-positioned. The image may, for example, be positioned in an inactive portion of the display.

In monitoring the interaction, a count of each actuation of the user interface element may be accumulated, and the modified image may be provided when the count reaches a predetermined number. Furthermore, a frequency of the actuation of the user interface element over a predetermined period of time may be determined, and the modified image may be provided when the frequency reaches a predetermined level.

In some cases, a presentation of the modified image of the user interface element may be maintained for a predetermined period of time. In addition, an input regarding presentation of the modified image of the user interface element may be received.

In another exemplary embodiment, an apparatus for providing adaptive user interface elements on display devices is provided. The apparatus may include a processing element. The processing element may be configured to provide for a display of an image of at least one user interface element associated with an application, wherein actuation of each user interface element invokes an operation related to the application. The processing element may also be configured to monitor interaction with each user interface element and to provide for a modified image of the at least one user interface element based on the interaction with the respective user interface element.

The processing element may further be configured to adjust one or more of a transparency, size, animation, and/or coloring of the image of the at least one user interface element. The processing element may also be configured to re-position the image of the at least one user interface element, for example, positioning the image in an inactive portion of the display.

In some cases, the processing element may be configured to accumulate a count of each actuation of the user interface element and to provide for the modified image when the count reaches a predetermined number. The processing element may also be configured to determine a frequency of the actuation of the user interface element over a predetermined period of time and to provide for the modified image when the frequency reaches a predetermined level.

The processing element may in some cases maintain a presentation of the modified image of the user interface element for a predetermined period of time. In some embodiments, the processing element may be configured to receive an input regarding presentation of the modified image of the user interface element.

In another exemplary embodiment, an apparatus for providing an adaptive keypad search on touch display devices is provided. The apparatus includes means for providing for a display of an image of at least one user interface element associated with an application, wherein actuation of each user interface element invokes an operation related to the application, as well as means for monitoring interaction with each user interface element and means for providing for a modified image of the at least one user interface element based on the interaction with the respective user interface element.

### BRIEF DESCRIPTION OF THE SEVERAL VIEWS OF THE DRAWING(S)

Having thus described embodiments of the invention in general terms, reference will now be made to the accompanying drawings, which are not necessarily drawn to scale, and wherein:

FIG. 1 is a schematic block diagram of a mobile terminal according to an exemplary embodiment of the present invention;

FIG. 2 is a schematic block diagram of an apparatus for providing adaptive user interface elements on display devices according to an exemplary embodiment of the present invention;

FIG. 3 illustrates an apparatus according to an exemplary embodiment of the present invention;

FIG. 4 illustrates a screenshot of an exemplary display in which user interface elements are displayed according to an exemplary embodiment of the present invention;

FIG. 5 illustrates a screenshot of an exemplary display in which user interface elements with adjusted transparency are displayed according to an exemplary embodiment of the present invention;

FIG. 6 illustrates a screenshot of an exemplary display in which user interface elements with adjusted transparency are displayed according to an exemplary embodiment of the present invention;

FIG. 7 illustrates a screenshot of an exemplary display in which user interface elements with adjusted size are displayed according to an exemplary embodiment of the present invention;

FIG. 8 illustrates a screenshot of an exemplary display in which user interface elements that have been re-positioned are displayed according to an exemplary embodiment of the present invention;

FIG. 9 illustrates a screenshot of an exemplary display in which user interface elements that have been re-positioned and have adjusted transparency are displayed according to an exemplary embodiment of the present invention;

FIG. 10 illustrates a screenshot of an exemplary display in which user interface elements that have been re-positioned via user input and have adjusted transparency are displayed according to an exemplary embodiment of the present invention;

FIG. 11 illustrates a screenshot of an exemplary display in which user interface elements including a mode change button are displayed according to an exemplary embodiment of the present invention;

FIG. 12 illustrates a screenshot of an exemplary display in which user interface elements that have been crossed out via user input are displayed according to an exemplary embodiment of the present invention; and

FIG. 13 is a block diagram according to an exemplary method for providing adaptive user interface elements on display devices according to an exemplary embodiment of the present invention.

### DETAILED DESCRIPTION

Embodiments of the present invention will now be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like reference numerals refer to like elements throughout.

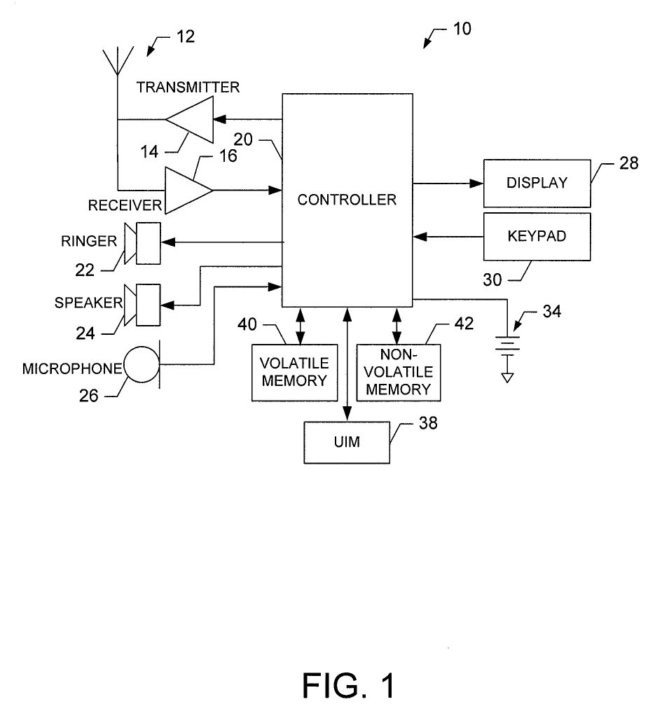

FIG. 1 illustrates a block diagram of a mobile terminal 10 that would benefit from embodiments of the present invention. It should be understood, however, that a mobile telephone as illustrated and hereinafter described is merely illustrative of one type of mobile terminal that would benefit from embodiments of the present invention and, therefore, should not be taken to limit the scope of embodiments of the present invention. While one embodiment of the mobile terminal 10 is illustrated and will be hereinafter described for purposes of example, other types of mobile terminals, such as portable digital assistants (PDAs), pagers, mobile computers, mobile televisions, gaming devices, laptop computers, cameras, video recorders, GPS devices and other types of voice and text communications systems, can readily employ embodiments of the present invention. Furthermore, devices that are not mobile may also readily employ embodiments of the present invention.

The system and method of embodiments of the present invention will be primarily described below in conjunction with mobile communications applications. However, it should be understood that the system and method of embodiments of the present invention can be utilized in conjunction with a variety of other applications, both in the mobile communications industries and outside of the mobile communications industries.

The mobile terminal 10 includes an antenna 12 (or multiple antennae) in operable communication with a transmitter 14 and a receiver 16. The mobile terminal 10 further includes an apparatus, such as a controller 20 or other processing element, that provides signals to and receives signals from the transmitter 14 and receiver 16, respectively. The signals include signaling information in accordance with the air interface standard of the applicable cellular system, and also user speech, received data and/or user generated data. In this regard, the mobile terminal 10 is capable of operating with one or more air interface standards, communication protocols, modulation types, and access types. By way of illustration, the mobile terminal 10 is capable of operating in accordance with any of a number of first, second, third and/or fourth-generation communication protocols or the like. For example, the mobile terminal 10 may be capable of operating in accordance with second-generation (2G) wireless communication protocols IS-136 (TDMA), GSM, and IS-95 (CDMA), or with third-generation (3G) wireless communication protocols, such as UMTS, CDMA2000, WCDMA and TD-SCDMA, with fourth-generation (4G) wireless communication protocols or the like.

It is understood that the apparatus, such as the controller 20, includes circuitry desirable for implementing audio and logic functions of the mobile terminal 10. For example, the controller 20 may be comprised of a digital signal processor device, a microprocessor device, and various analog to digital converters, digital to analog converters, and other support circuits. Control and signal processing functions of the mobile terminal 10 are allocated between these devices according to their respective capabilities. The controller 20 thus may also include the functionality to convolutionally encode and interleave message and data prior to modulation and transmission. The controller 20 can additionally include an internal voice coder, and may include an internal data modem. Further, the controller 20 may include functionality to operate one or more software programs, which may be stored in memory. For example, the controller 20 may be capable of operating a connectivity program, such as a conventional Web browser. The connectivity program may then allow the mobile terminal 10 to transmit and receive Web content, such as location-based content and/or other web page content, according to a Wireless Application Protocol (WAP), Hypertext Transfer Protocol (HTTP) and/or the like, for example.

The mobile terminal 10 may also comprise a user interface including an output device such as a ringer 22, a conventional earphone or speaker 24, a microphone 26, a display 28, and a hardware user input interface, all of which are coupled to the controller 20. The hardware user input interface, which allows the mobile terminal 10 to receive data, may include any of a number of devices allowing the mobile terminal 10 to receive data, such as a keypad 30, a touch display (not shown) or other input device. In embodiments including the keypad 30, the keypad 30 may include the conventional numeric (0-9) and related keys (#, *), and other keys used for operating the mobile terminal 10. Alternatively, the keypad 30 may include a conventional QWERTY keypad arrangement. The keypad 30 may also include various soft keys with associated functions. In addition, or alternatively, the mobile terminal 10 may include an interface device such as a joystick or other hardware user input interface. The mobile terminal 10 further includes a battery 34, such as a vibrating battery pack, for powering various circuits that are required to operate the mobile terminal 10, as well as optionally providing mechanical vibration as a detectable output.

The mobile terminal 10 may further include a user identity module (UIM) 38. The UIM 38 is typically a memory device having a processor built in. The UIM 38 may include, for example, a subscriber identity module (SIM), a universal integrated circuit card (UICC), a universal subscriber identity module (USIM), a removable user identity module (R-UIM), etc. The UIM 38 typically stores information elements related to a mobile subscriber. In addition to the UIM 38, the mobile terminal 10 may be equipped with memory. For example, the mobile terminal 10 may include volatile memory 40, such as volatile Random Access Memory (RAM) including a cache area for the temporary storage of data. The mobile terminal 10 may also include other non-volatile memory 42, which can be embedded and/or may be removable. The non-volatile memory 42 can additionally or alternatively comprise an EEPROM, flash memory or the like, such as that available from the SanDisk Corporation of Sunnyvale, Calif., or Lexar Media Inc. of Fremont, Calif. The memories can store any of a number of pieces of information, and data, used by the mobile terminal 10 to implement the functions of the mobile terminal 10. For example, the memories can include an identifier, such as an international mobile equipment identification (IMEI) code, capable of uniquely identifying the mobile terminal 10.

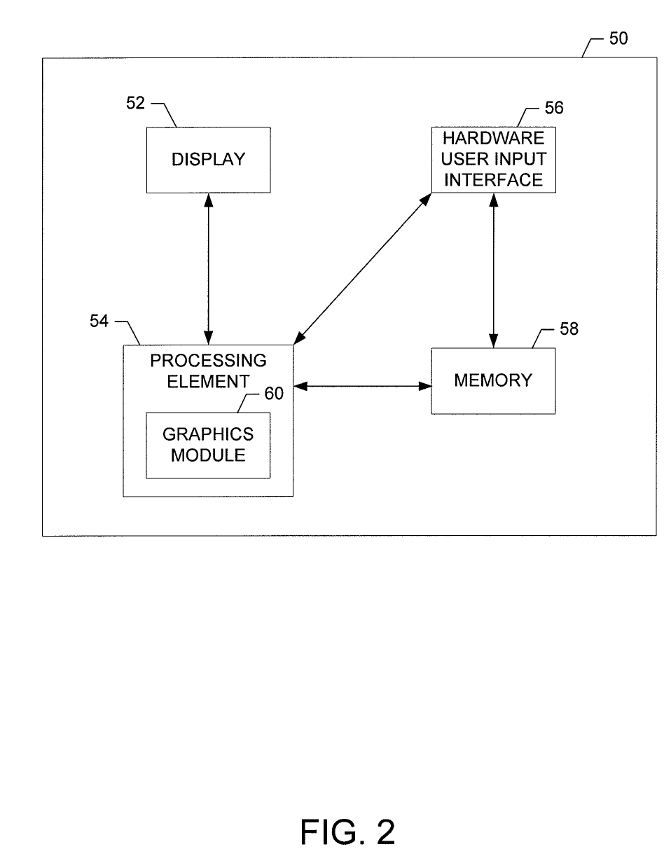

An exemplary embodiment of the invention will now be described with reference to FIG. 2, in which certain elements of an apparatus for providing adaptive user interface elements on display devices are illustrated. The apparatus of FIG. 2 may be employed, for example, in conjunction with the mobile terminal 10 of FIG. 1. However, it should be noted that the apparatus of FIG. 2, may also be employed in connection with a variety of other devices, both mobile and fixed, and therefore, embodiments of the present invention should not be limited to application on devices such as the mobile terminal 10 of FIG. 1. It should also be noted that while FIG. 2 illustrates one example of a configuration of an apparatus for providing adaptive user interface elements, numerous other configurations may also be used to implement embodiments of the present invention.

Referring now to FIG. 2, an apparatus 50 for providing adaptive user interface elements on display devices is illustrated. The apparatus 50 may include or otherwise be in communication with a display 52 (e.g., the display 28 of FIG. 1), means, such as a processing element 54 (e.g., the controller 20 of FIG. 1), for driving the display 52 and for monitoring and adapting the user interface element(s), a hardware user input interface 56 (e.g., the keypad 30 of FIG. 1), and a memory device 58. The memory 58 may include, for example, volatile and/or non-volatile memory (e.g., volatile memory 40 and/or non-volatile memory 42 of FIG. 1). The memory 58 may be configured to store information, data, applications, instructions or the like for enabling the apparatus to carry out various functions in accordance with exemplary embodiments of the present invention. For example, the memory 58 may be configured to buffer input data for processing by the processing element 54. Additionally or alternatively, the memory 58 may be configured to store instructions for execution by the processing element 54, including a software platform for providing for the display of user interface elements upon the display 52 and/or instructions for executing a software application.

The processing element 54 may be embodied in a number of different ways. For example, the processing element 54 may be embodied as a processor, a coprocessor, a controller or various other processing means or devices including integrated circuits such as, for example, an ASIC (application specific integrated circuit). In an exemplary embodiment, the processing element 54 may be configured to execute instructions stored in the memory 58 or otherwise accessible to the processing element 54. Furthermore, the processing element 54 may include or otherwise be in communication with a graphics module 60, which may be configured to present images on the display 52 according to instructions provided by the processing element 54.

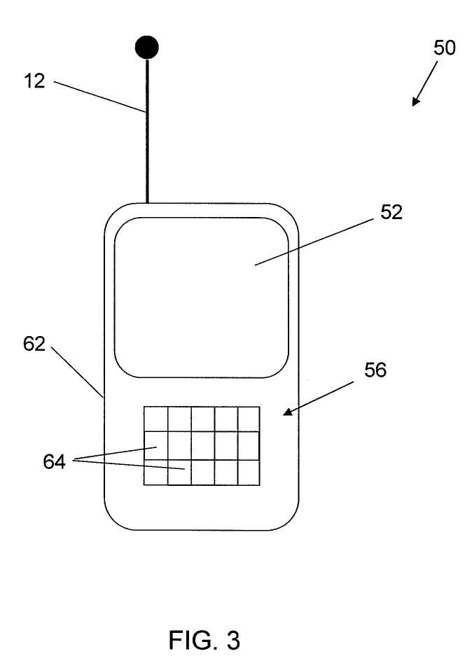

Referring to FIG. 3, the apparatus 50, which may include the mobile terminal 10 of FIG. 1, may include a housing 62 carrying an antenna 12, the display 52, and the hardware user input interface 56. In FIG. 3, the hardware user input interface 56 includes fifteen keys 64, which may be, for example, alpha-numeric keys. However, the hardware user input interface 56 may include any number of keys as well as other types of user input devices, such as joysticks, buttons, switches, or any combination thereof, depending on the type of apparatus 50. For example, the hardware user input interface 56 of a mobile telephone may be configured differently than the hardware user input interface 56 of a PDA to accommodate the functions typically offered by the respective apparatus.

Although the hardware user input interface 56 may be configured to accommodate certain software applications implemented by the processing element 54 of FIG. 2, some applications may require the provision of user interface elements on the display 52 of the apparatus 50. For example, a gaming application may be invoked by a user of the apparatus 50, and the hardware user input interface 56 may not adequately allow the processing element 54 (shown in FIG. 2) to receive user inputs regarding operation of the gaming application. In this case, a software platform may be executed by the processing element 54, in conjunction with the gaming application, to provide user interface elements upon the display 52 to supplement or replace the controls provided by the hardware user input interface 56.

The processing element 54 of the apparatus is thus configured to provide for a display of an image of one or more user interface elements associated with the application such that the actuation of each user interface element invokes an operation related to the application. Furthermore, the processing element 54 is configured to monitor interaction with each user interface element and provide for a modified image of the user interface element based on the interaction with the respective user interface element. As a result, user interface elements with which interaction is limited (indicating, for example, that the user does not require or is choosing not to actuate those elements) may be de-emphasized, and user interface elements with which interaction is more prevalent may be emphasized, as described below. In other words, the provision of the user interface elements may be modified to allow the user to view those user interface elements with which the user is concerned overlaying the presentation of the application without providing all the available user interface elements such that viewing of the application is unnecessarily obscured.

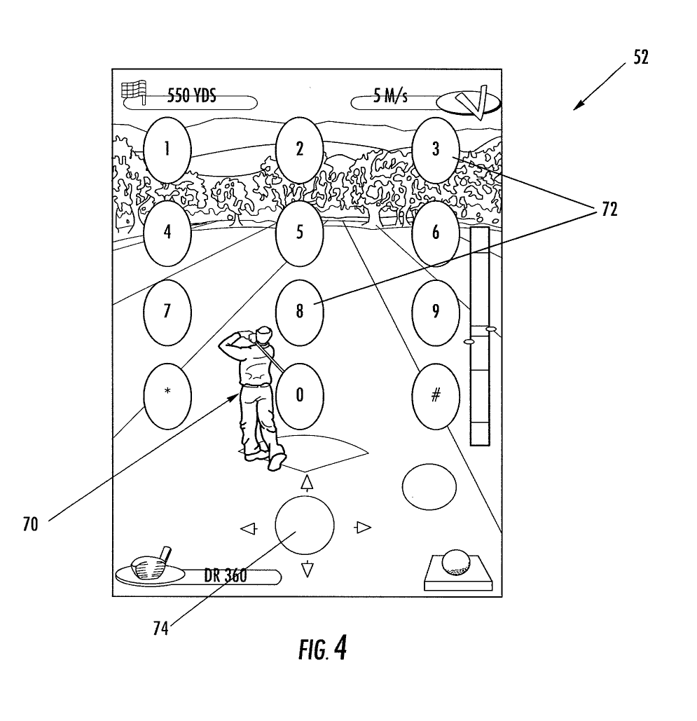

In this regard, FIG. 4 depicts a display 52 presenting graphics associated with a particular application in the background 70 as well as images of user interface elements 72 in the foreground. In the example illustrated in FIG. 4, the user interface elements 72 include thirteen circular buttons as well as a scrolling button 74. A user may actuate one or more of the user interface elements 72 in a number of ways to invoke certain operations of the application. For example, the display 52 may be a touch screen display, and the user interface elements 72 may be actuated via touch events, such as by using a stylus or the user's finger to touch the display 52 in the area of the desired user interface element 72. Alternatively, the one or more keys 64 of the hardware user interface 56 of FIG. 3 may be used to highlight and select certain user interface elements 72, thereby actuating the selected user interface elements 72. Actuation of one or more user interface elements 72 may invoke a variety of operations related to the application. For example, in a gaming application such as a golf video game, the user interface elements 72 may be used to specify a direction and strength of a golf swing. In a calendar application, on the other hand, the user interface elements 72 may be used to enter appointment dates, times, and other details.

As a user interacts with the user interface elements 72 to control a particular application, one or more of the user interface elements 72 may be used to a greater extent than others. This may be because the user favors certain functions of the application or prefers to control the application in a certain way. In the example of the golf video game application, the user may favor using the scrolling button 74 to control the direction of the swing rather than entering a specific angle via the numeric user interface elements 72. The result of the user's preference may be that the user actuates the scrolling button 74 more frequently than the other user interface elements 72. By monitoring the user's interaction with the user interface elements (i.e., the user's actuation or non-actuation of each user interface element), the processing element may determine which user interface elements 72 to emphasize and which to de-emphasize to allow the user to view more of the application.

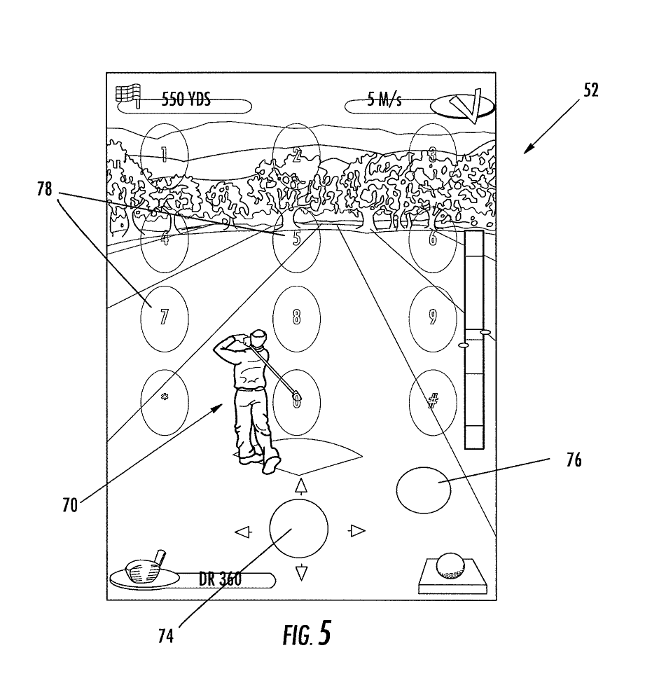

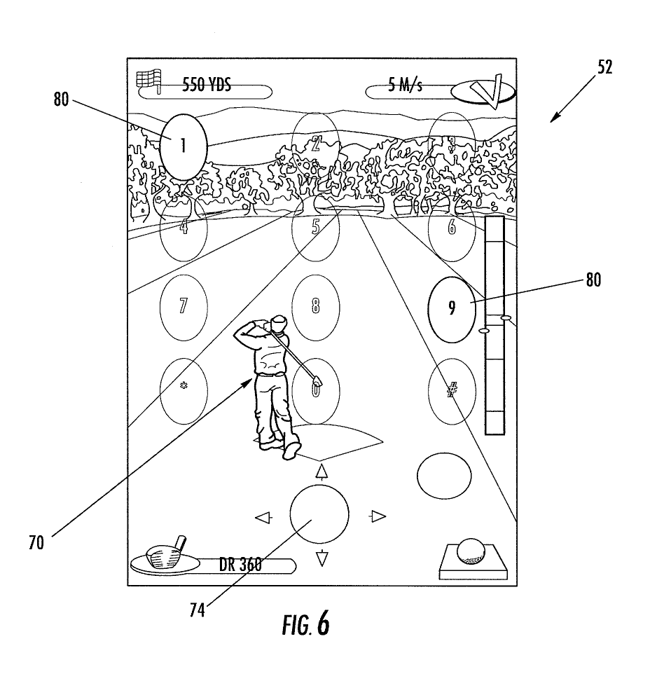

The processing element 54 of FIG. 2 may be configured to provide for a modified image of one or more user interface elements 72 in a variety of ways. In some cases, the processing element 72 may adjust a characteristic of the image of a given user interface element 72 in order to emphasize or de-emphasize the respective user interface element 72. For example, the transparency of the user interface element 72 may be adjusted, such that user interface elements 72 that are not favored by the user are made more transparent (allowing more of the application presented in the background to be seen). FIG. 5 illustrates an example in which the scrolling button 74 and auxiliary button 76 are favored (e.g., actuated more frequently) by the user, and the other user interface elements 78 are not favored (e.g., actuated less frequently). As a result, the less favored user interface elements 78 appear more transparent than the favored user interface elements 74, 76, and the background 70 showing the graphics of the application are thus more visible from behind the transparent user interface elements. If, as the user continues to interact with the user interface elements, the user begins to favor additional user interface elements (such as the “1” and “9” buttons), the transparency of the newly favored user interface elements 80 may be decreased to make them more visible (and thus easier to actuate), as illustrated in FIG. 6.

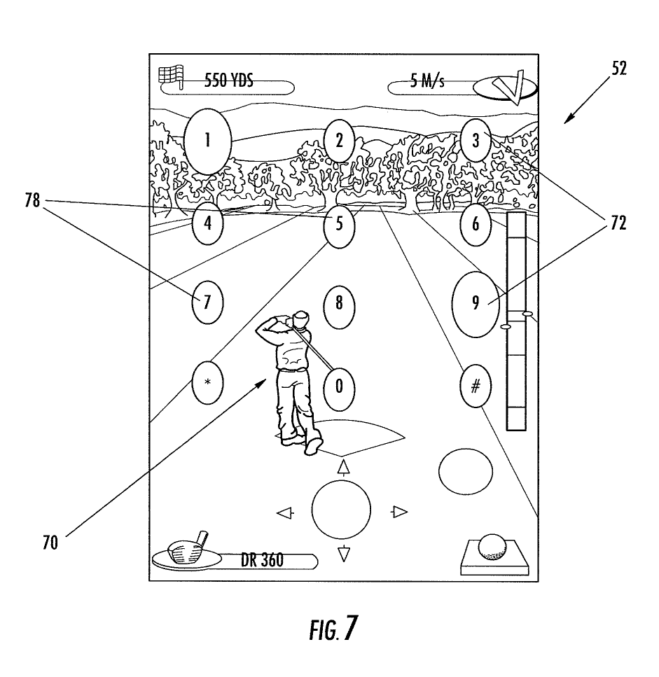

The processing element 54 of FIG. 2 may be configured to adjust other characteristics of the image of the user interface elements based on the interaction with the respective user interface element. For example, the size of the user interface element 72 may be adjusted. In FIG. 7, for example, less favored user interface elements 78 have been decreased in size to allow more of the application displayed in the background 70 to be visible. Alternatively, all of the user interface elements 72 may be presented in a “small” size at the initiation of the application, and the size of favored user interface elements may be increased as the user begins to actuate those user interface elements.

As another example, the animation and/or coloring of the user interface elements may also be adjusted to emphasize or de-emphasize certain user interface elements depending on the interaction with those user interface elements. For example, favored user interface elements may be animated to make them more visible to the user for actuation, such as by causing the user interface element to flash on the display or move in some other way. Using color, less favored user interface elements may be adjusted to have a color similar to the color of the background 70, such that they appear to blend in with the background. Favored user interface elements, on the other hand, may be assigned colors that contrast with or stand out from the colors of the background 70. For example, a favored user interface element may be colored red when overlying a light green background.

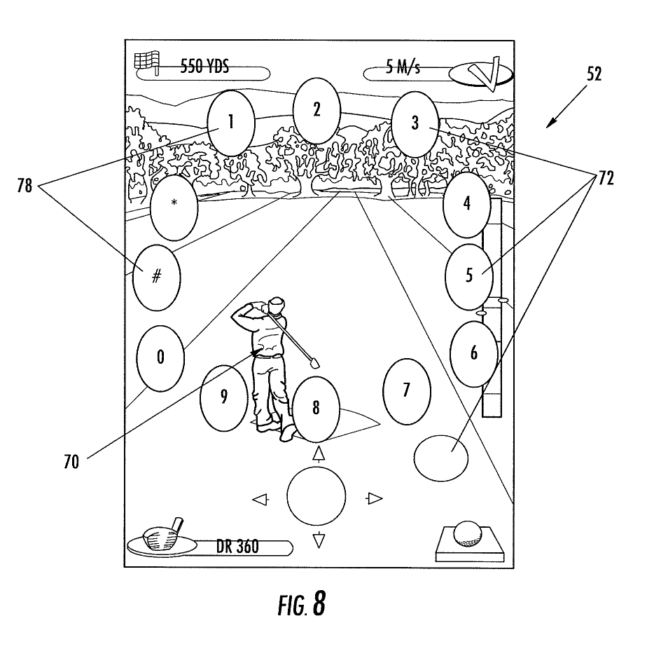

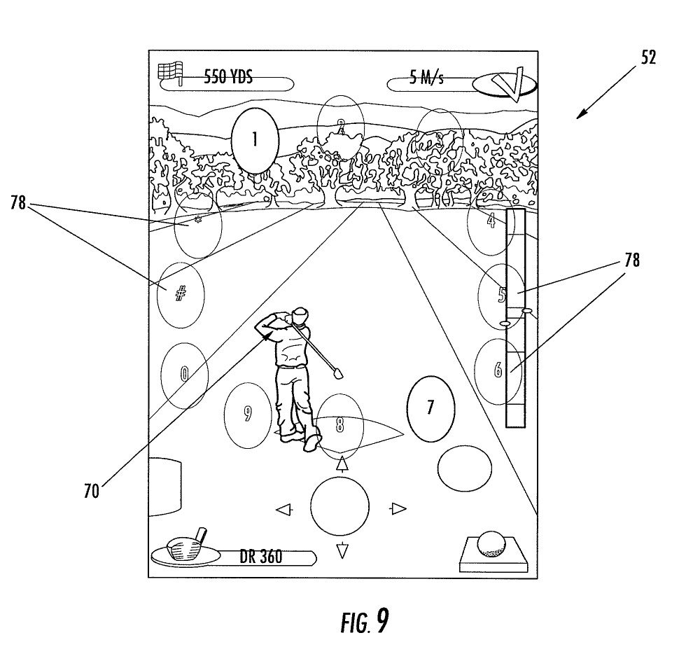

In other embodiments, the processing element 54 of FIG. 2 may be configured to re-position the image of the user interface elements based on the interaction with the respective user interface element. Referring to FIG. 8, for example, less favored user interface elements 78 (which, in this case are the numeric buttons) are re-positioned in a circular configuration such that they no longer obscure the center portion of the display, where the user may be more interested in viewing the application graphics presented in the background 70. Thus, the processing element 54 may be configured to position the image of the user interface element in an inactive portion of the display 52, such as the periphery (as in FIG. 8) or any other portion of the display 52 that the user may not be as interested in viewing. Furthermore, two or more of the adjustments described above may be combined to provide the modified images. For example, less favored user interface elements 78 may both be re-positioned (e.g., positioned in a circular configuration) and increased in transparency to allow the user to view more of the application presented in the background 70, as illustrated in FIG. 9.

The processing element 54 of FIG. 2 may be configured to provide for the modified images by monitoring interaction with each user interface element in various ways. For example, the processing element may accumulate a count of each actuation of the user interface elements and to provide for the modified image when the count reaches a predetermined number. Thus, for any given user interface element 72, the processing element may count the number of times a user actuates that user interface element, and when the user has actuated the user interface element a certain number of times (such as 10 or 20 times), that particular user interface element may be emphasized (and other user interface elements may be de-emphasized) in one or more of the ways described above. In some cases, the count may restart with each power cycle of the apparatus, or upon each invocation of the application, or otherwise as configured by the user.

Alternatively, the processing element may be configured to determine a frequency of the actuation of each respective user interface element over a predetermined period of time and to provide for the modified image when the frequency reaches a predetermined level. For example, interaction with a given user interface element may be monitored in five-minute intervals. If, within an interval of monitoring, the number of actuations of the user interface element drops below a certain predetermined number (such as 20 actuations), that particular user interface element may be de-emphasized in any one or more of the ways described above. Alternatively or additionally, if, within the interval of monitoring, the number of actuations of the user interface element exceeds a certain predetermined number (such as 30 actuations), that particular user interface element may be emphasized. The predetermined number, for emphasis or de-emphasis determinations, may be dependent on the type of application involved and may take into account a typical number of actuations expected over a given period of time. Such a number may be included in the instructions for executing the particular application or associated software platform for providing the user interface elements, or the number may be determined or modified by a user depending on the user's preferences.

Furthermore, the processing element 54 of FIG. 2 may be configured to maintain a presentation of the modified image of the user interface element for a predetermined period of time. For example, the modified images illustrated in the figures may continue to be presented using the same modified appearance for five minutes. After such time, the processing element may determine (in one or more of the ways described above) whether a given user interface element should continue to be emphasized or de-emphasized, based on subsequent interaction with the user interface element. In this way, if a particular user interface element had been favored at one time but is no longer favored, the presentation of that user interface element may be adjusted to account for this change.

In other embodiments, the processing element may be configured to monitor the interaction with the user interface element over longer periods of time, such as over the duration of the application's operation or over multiple instances of the application's operation. The processing element may maintain statistical information regarding the interaction with each user interface element, for example in the memory 58 shown in FIG. 2, such that a pattern of interaction may be determined, and the image of each user interface element may be modified according to such pattern. In this way, the processing element may “learn” a user's actuation preferences for interacting with a particular application or application view or for engaging a particular use case, and each time the application or use case is invoked, the user interface elements may be presented according to those learned preferences.

In this regard, a use case may include performing a particular task in an application. For example, a user may be engaged in a telephone call on the mobile terminal, and the application for the telephone call may provide for the display of user interface elements pertaining to volume control which the user may occasionally utilize. During the phone conversation, the user may access a different application, such as a calendar application, but may still have access to the user interface elements for controlling volume associated with the telephone application. Thus, for example, the processing element may be configured to monitor the user's interaction with the user interface elements when the calendar application is accessed and recall such “learned” preferences the next time the calendar application is invoked in conjunction with the telephone application, for example, de-emphasizing the volume controls in the calendar application if the user did not use them.

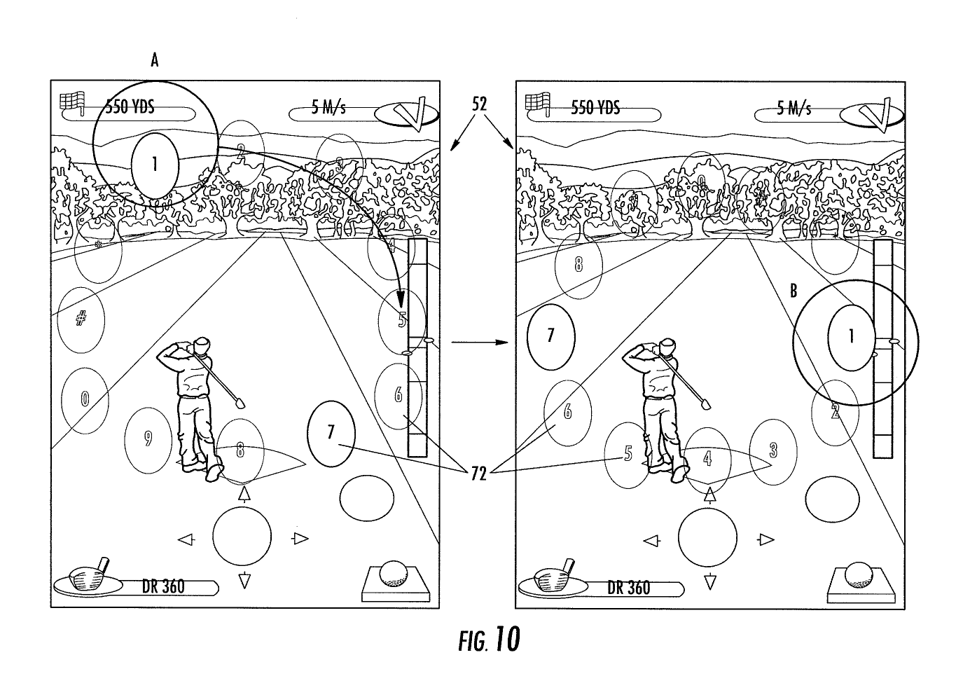

The processing element 54 of FIG. 2 may, in some cases, be configured to receive an input regarding the presentation of the modified image of the user interface element, for example from the user himself. For instance, if the display 52 is a touch screen display, the user may be able to manually re-position the user interface elements 72 by touching the display 52 at one user interface element A and dragging the user interface element A to a new position B, as illustrated in FIG. 10. As a result, other user interface elements 72 may automatically be re-positioned to assume a similar configuration (e.g., the same circular configuration), but in a different location.

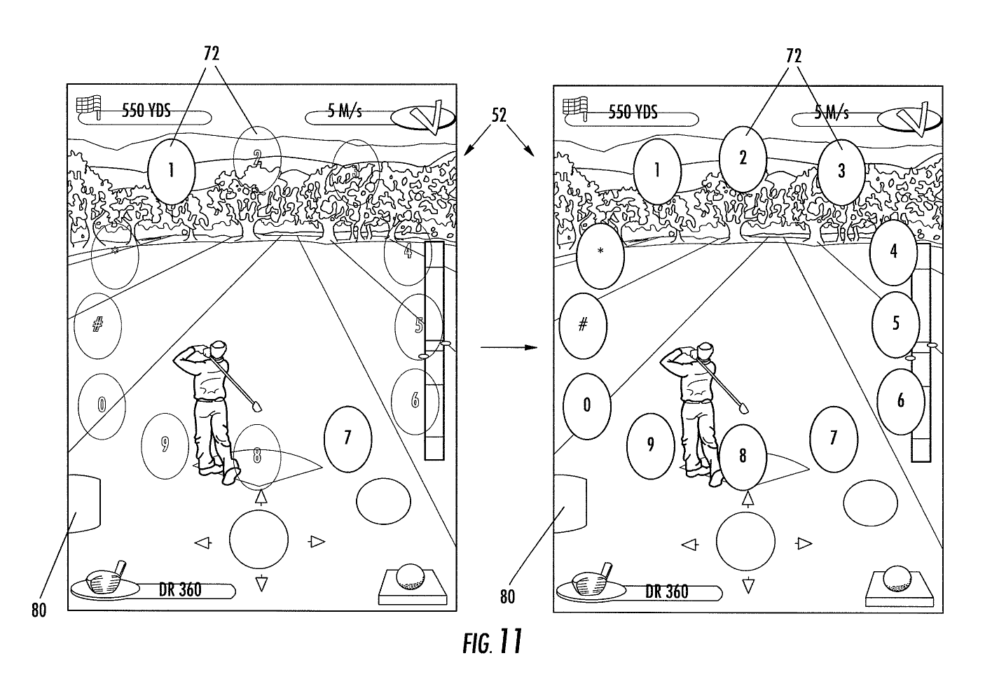

As another example, illustrated in FIG. 11, the processing element may be configured to provide for additional user interface elements to allow a user to adjust certain characteristics of the user interface elements, such as a “mode change” button 80. Actuation of the mode change button 80, for example, may cause the processing element to reposition the user interface elements 72, for example into a circular configuration, and may also cause other adjustments, such as decreasing the transparency of the user interface elements 72. Different “modes,” or configurations of the user interface elements, may be pre-set by the application and/or predefined by the user such that a single actuation of the mode change button 80 will modify the image of the user interface elements 72. Additional actuations of the mode button 80 may cause the configuration of the user interface elements to change again, in effect cycling through two or more pre-set configurations.

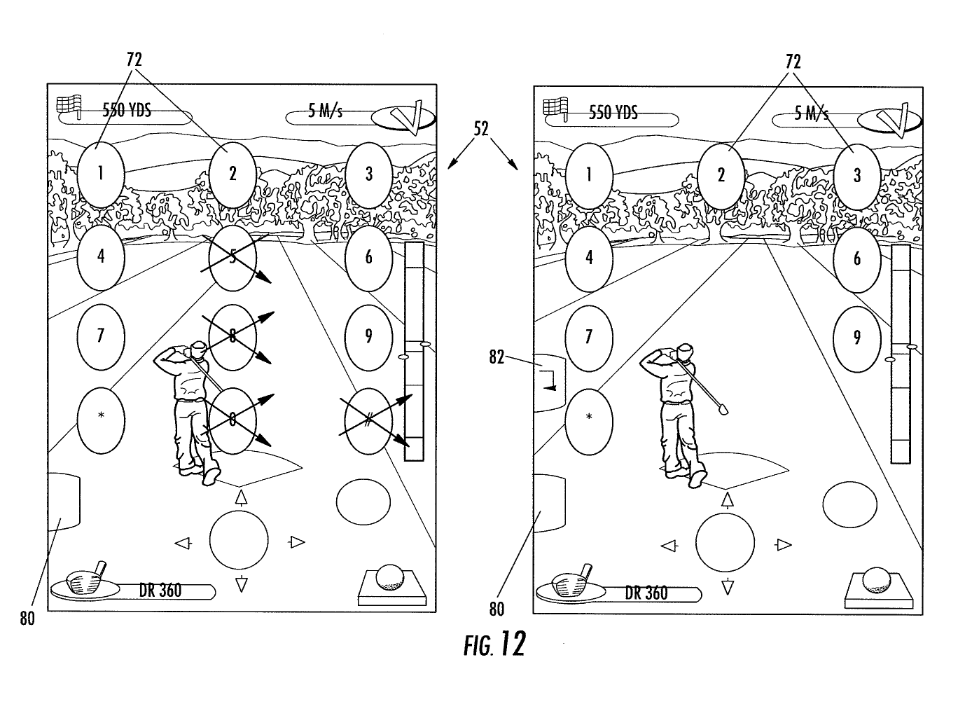

A user may also provide an input to the processing element by deleting certain user interface elements that the user prefers not to see. In the case of a touch screen display, the user may “cross out” any unwanted user interface elements 72 by making an “X” (such as with a stylus touching the display) to delete those user interface elements, as depicted in FIG. 12. Alternatively, keys of the mobile terminal may be used to select and delete certain unwanted user interface elements. Upon deleting a user interface element 72, the processing element may be configured to provide for an image of an “undo” button 82 to be displayed, such that a user's actuation of the undo button 82 may revert the user interface elements 72 to a prior presentation, such as the last configuration used. Furthermore, the processing element may be configured to receive more than one form of input from the user, including more than one of the types of inputs described above (such as “crossing out” and dragging user interface elements to a new position).

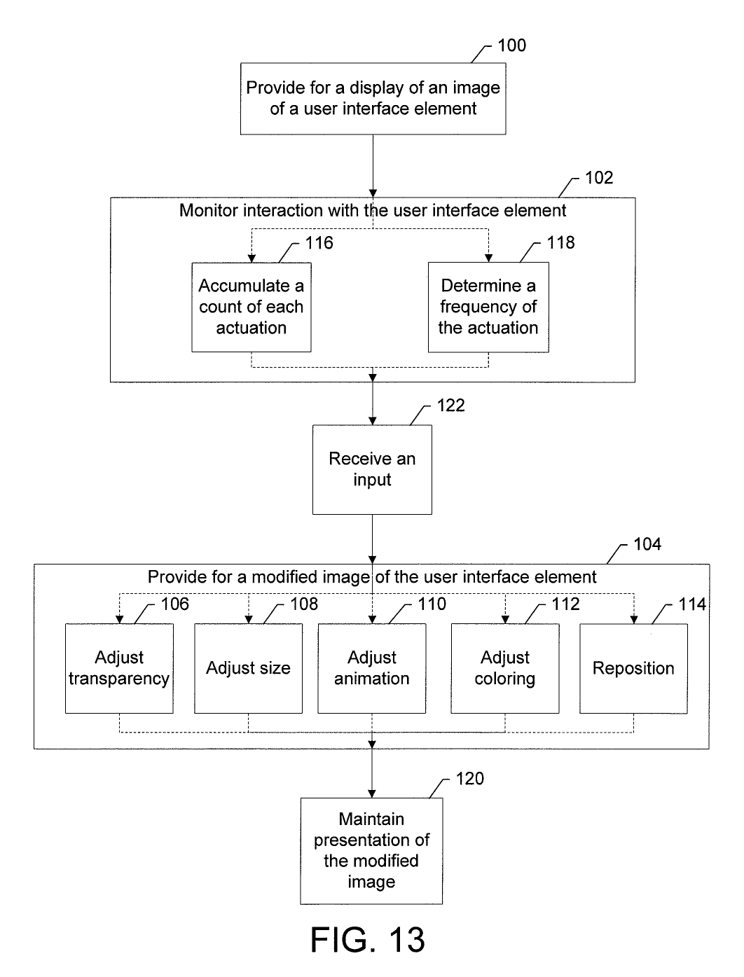

In other embodiments, a method for providing adaptive user interface elements on display devices is provided. Referring to FIG. 13, a display of an image of one or more user interface elements is provided, for example according to instructions provided in a software application. Interaction with each user interface element is then monitored, and a modified image of the user interface element is provided based on the interaction with the respective user interface element. FIG. 13, blocks 100-104.

As described above, the user interface elements may be modified in various ways. For example, a transparency of the image of a particular user interface element may be adjusted, or the size of the user interface element may be changed (i.e., made smaller to de-emphasize the element or larger to emphasize the element to the user). Blocks 106, 108. Furthermore, an animation of the user interface element may be adjusted, such as by causing the image to appear in motion or to flash. Block 110. In other cases, the coloring of the user interface element may be adjusted, causing the element to stand out from or blend in with the background display, or the user interface element may be re-positioned, for example to position the element in an inactive portion of the display. Blocks 112, 114. In some cases, a user interface element may be modified in more than one way, such as by adjusting the coloring and re-positioning the element.

Interaction with each user interface element may be monitored in various ways, as well. As described above, a count of each actuation of the user interface element may be accumulated, such that the modified image may be provided when the count reaches a predetermined number. Block 116. For example, once a particular user interface element has been actuated a certain number of times, such as 5 times, the user interface element may be emphasized in one or more of the ways described above and illustrated in the figures. Alternatively, a frequency of the actuation of the user interface element may be determined over a predetermined period of time, such that when the frequency reaches a predetermined level, the modified image is provided. Block 118. For example, if a certain user interface element is not actuated within a five minute time frame, that user interface element may be de-emphasized in one or more of the ways described above to allow the user to view more of the application.

In some cases, presentation of the modified image may be maintained for a predetermined period of time, such as for the duration of the application's operation or for ten minutes. Block 120. Subsequent monitoring may inform the provision of further modified images after the period of time has passed, as described above. In some embodiments, an input may be received, for example from a user, regarding presentation of the modified image of the user interface element. Block 122. For example, a user may drag the user input elements to different positions using a touch screen display, eliminate certain user input elements by crossing them out or deleting them, or change a configuration of the user input elements by actuating a mode change button, as described above. Although receipt of an input (block 122) is shown in FIG. 13 as occurring after interaction is monitored and before the modified image is provided, an input may be received at any time. For example, the user may provide an input regarding presentation of the user interface elements before the elements are displayed (block 100) or even after the modified image has been provided (block 104).

Exemplary embodiments of the present invention have been described above with reference to block diagrams and flowchart illustrations of methods, apparatuses, and computer program products. It will be understood that each block of the block diagrams and flowchart illustrations, and combinations of blocks in the block diagrams and flowchart illustrations, respectively, can be implemented by various means including computer program instructions. These computer program instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus, such as a processor including, for example, the controller 20 (shown in FIG. 1) and/or the processing element 52 (shown in FIG. 2), to function in a particular manner, such that the instructions stored in the computer-readable memory produce an article of manufacture including computer-readable instructions for implementing the function specified in the flowchart block or blocks illustrated in FIG. 13. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

Many modifications and other embodiments of the inventions set forth herein will come to mind to one skilled in the art to which these embodiments pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A method comprising:
providing for a display of an image of at least one user interface element associated with an application, wherein actuation of each user interface element invokes an operation related to the application;
monitoring interaction with each user interface element; and
providing for a modified image of the at least one user interface element based on the interaction with the respective user interface element.

2. The method of claim 1, wherein providing for the modified image comprises adjusting at least one characteristic of the image of the at least one user interface element, the characteristic selected from the group consisting of a transparency, a size, an animation, and a coloring.

3. The method of claim 1, wherein providing for the modified image comprises re-positioning the image of the at least one user interface element.

4. The method of claim 3, wherein re-positioning the image comprises positioning the image of the user interface element in an inactive portion of the display.

5. The method of claim 1, wherein monitoring the interaction comprises accumulating a count of each actuation of the user interface element, and wherein providing for the modified image comprises providing for the modified image when the count reaches a predetermined number.

6. The method of claim 1, wherein monitoring the interaction comprises determining a frequency of the actuation of the user interface element over a predetermined period of time, and wherein providing for the modified image comprises providing for the modified image when the frequency reaches a predetermined level.

7. The method of claim 1 further comprising maintaining a presentation of the modified image of the user interface element for a predetermined period of time.

8. The method of claim 1 further comprising receiving an input regarding presentation of the modified image of the user interface element.

9. A computer program product comprising at least one computer-readable storage medium having computer-readable program code portions stored therein, the computer-readable program code portions comprising:
a first executable portion for providing for a display of an image of at least one user interface element associated with an application, wherein actuation of each user interface element invokes an operation related to the application;
a second executable portion for monitoring interaction with each user interface element; and
a third executable portion for providing for a modified image of the at least one user interface element based on the interaction with the respective user interface element.

10. The computer program product of claim 9, wherein the third executable portion comprises adjusting at least one characteristic of the image of the at least one user interface element, the characteristic selected from the group consisting of a transparency, a size, an animation, and a coloring.

11. The computer program product of claim 9, wherein the third executable portion comprises re-positioning the image of the at least one user interface element.

12. The computer program product of claim 11, wherein the third executable portion further comprises positioning the image of the user interface element in an inactive portion of the display.

13. The computer program product of claim 9, wherein the second executable portion comprises accumulating a count of each actuation of the user interface element, and wherein providing for the modified image comprises providing for the modified image when the count reaches a predetermined number.

14. The computer program product of claim 9, wherein the second executable portion comprises determining a frequency of the actuation of the user interface element over a predetermined period of time, and wherein providing for the modified image comprises providing for the modified image when the frequency reaches a predetermined level.

15. The computer program product of claim 9 further comprising a fourth executable portion for maintaining a presentation of the modified image of the user interface element for a predetermined period of time.

16. The computer program product of claim 9 further comprising a fourth executable portion for receiving an input regarding presentation of the modified image of the user interface element.

17. An apparatus comprising a processing element configured to:
provide for a display of an image of at least one user interface element associated with an application, wherein actuation of each user interface element invokes an operation related to the application;
monitor interaction with each user interface element; and
provide for a modified image of the at least one user interface element based on the interaction with the respective user interface element.

18. The apparatus of claim 17, wherein the processing element is further configured to adjust at least one characteristic of the image of the at least one user interface element, the characteristic selected from the group consisting of a transparency, a size, an animation, and a coloring.

19. The apparatus of claim 17, wherein the processing element is further configured to re-position the image of the at least one user interface element.

20. The apparatus of claim 19, wherein the processing element is further configured to position the image of the user interface element in an inactive portion of the display.

21. The apparatus of claim 17, wherein the processing element is further configured to accumulate a count of each actuation of the user interface element and to provide for the modified image when the count reaches a predetermined number.

22. The apparatus of claim 17, wherein the processing element is further configured to determine a frequency of the actuation of the user interface element over a predetermined period of time and to provide for the modified image when the frequency reaches a predetermined level.

23. The apparatus of claim 17, wherein the processing element is further configured to maintain a presentation of the modified image of the user interface element for a predetermined period of time.

24. The apparatus of claim 17, wherein the processing element is further configured to receive an input regarding presentation of the modified image of the user interface element.

25. An apparatus comprising:
means for providing for a display of an image of at least one user interface element associated with an application, wherein actuation of each user interface element invokes an operation related to the application;
means for monitoring interaction with each user interface element; and
means for providing for a modified image of the at least one user interface element based on the interaction with the respective user interface element.
